(19) United States
(12) Patent Application Publication
(10) Pub. No.: US 2010/0320862 A1
(43) Pub. Date: Dec. 23, 2010

(54) X-watt Power Motor

(76) Inventor: Thomas E. Cook, Henderson, NV (US)

Correspondence Address: Thomas E. Cook, 1210 Toledo ST., Henderson, NV, 89015, US

(21) Appl. No.: 12/487,636

(22) Filed: Jun. 18, 2009

(51) Int. Cl. H02K 3/28; H02K 53/00

(52) U.S. Cl. 310/198; 415/916

(57) ABSTRACT

An X-watt Power Motor is an electric motor combined with an electricity generator that uses the motion created by the motor to generate electricity and uses the electricity from the generator to power the motor. The motor functionality replaces electromagnets with electrical transformers which are named transformer magnets. Electricity generated from common electricity collector coils in a multi-chambered motor can be combined and sent to the corresponding transformer magnet of a single chamber. The equivilent combined electrical current can then be passed to all of the common transformer magnets in every chamber and then out of the motor. The result is that each transformer magnet will receive an electrical charge that is equal to the number of chambers in the motor multiplied by the electricity generated from a single electricity collector coil. These factors combine to create a powerful electric motor that only requires electricity to be started and outputs electricity while running.

### BRIEF SUMMARY OF THE INVENTION

The invention is an X-watt Power Motor. An X-watt Power Motor is an electric motor combined with an electricity generator that uses the motion created by the motor to generate electricity and uses the electricity from the generator to power the motor. The motor functionality replaces electromagnets with electrical transformers, which are named transformer magnets. Electricity generated from common electricity collector coils in a multi-chambered motor can be combined and sent to the corresponding transformer magnet of a single chamber. The equivalent combined electrical current can then be passed to all of the common transformer magnets in every chamber and then out of the motor. The result is that each transformer magnet will receive an electrical charge that is equal to the number of chambers in the motor multiplied by the electricity generated from a single electricity collector coil. These factors combine to create a powerful electric motor that only requires electricity to be started and outputs electricity while running.

### BACKGROUND OF THE INVENTION

The prior art concerning the X-watt Power Motor can be found in three separate devices, all of which were discovered or invented by Michael Faraday in England in 1831. The three devices are the electric motor, the electrical transformer, and the electricity generator. Understanding how these devices work is crucial to understanding how the X-watt Power Motor works.

A traditional electric motor is comprised of a chamber that has a shaft mounted so that the shaft can spin freely inside the chamber and protrude out of the chamber where the torque created by the motor can be employed. Inside of the chamber permanent magnets are attached to the shaft so that they protrude outward from the shaft in opposite directions allowing the shaft to spin in a balanced manner. Permanent magnets have a plus polarity on one side and a negative polarity on the opposite side. The polarities of the permanent magnets are alternated as viewed from the shaft or outside of the shaft. Electro magnets are attached in a stationary position on the interior of the chamber and as close as they can get to the path of the permanent magnets while still being outside of the path of the permanent magnets as they spin. Electromagnets are created by coiling magnetic wire around an iron core and sending an electric current through the wire. The polarity of the electromagnet depends on the direction that the wire is wrapped around the core and the direction of the current. While numerous configurations regarding the number of electromagnets and permanent magnets are possible, for explanatory purposes we will assume that a motor has two permanent magnets and two electromagnets. If the two electromagnets on opposite sides of the chamber have their coils wrapped in opposite directions then when the same DC or direct current electricity is applied to them they will have opposite inward facing polarities. As a result of the polarities of the electromagnets the permanent magnets will be attracted to the one with the opposite polarity and repelled by the one with the same polarity. When an AC or alternating current is applied to the electromagnets their polarity repeatedly switches causing the permanent magnets to repeatedly spin which in turn creates torque on the shaft outside of the chamber.

An electrical transformer works based on one of the two types of electromagnetic induction that Faraday discovered called “mutual electromagnetic induction.” If you wrap a coil of wire around an iron core and call it the primary coil and you wrap another coil of wire around the same iron core and call it the secondary coil and then you run a voltage through the primary coil a corresponding voltage can be measured in the secondary coil. That is assuming that the primary and secondary coils are wrapped in a parallel direction and that the number of times that the primary coil and secondary coil are wrapped around the iron is equal. Increasing or decreasing the number of wraps in the secondary coil in relation to the primary coil will correspondingly increase or decrease the voltage of the secondary coil. However the wattage remains constant and equal as amperage and voltage have a reverse correlation as per Ohms law. Also, the surge of electricity in the secondary coil will only last as long as the initial surge or flux lasts in the primary coil. This problem is overcome by using AC current, each time the current alternates it creates flux in the primary coil.

A traditional electricity generator works based on the other type of electromagnetic induction that Faraday discovered which is just called “electromagnetic induction.” An electricity generator is essentially an inverted electric motor; instead of using electricity to spin a shaft it uses a spinning shaft to make electricity. While numerous possibilities are available for the designs of electricity generators, for explanatory purposes we will be describing an electricity generator that is essentially the inverse of the electric motor described above. The chamber, shaft, and permanent magnets are identical but there are no electromagnets. Instead coils of magnetic wire are placed where the electromagnets would be and they are turned ninety degrees so that one side of the coil is as close to the path of the permanent magnets as possible and the other side is far enough away from the path that it is not exposed to the magnetic field as it passes. When the shaft is caused to spin due to physical torque applied from outside of the chamber the permanent magnets will spin passed one side of each of the coils and the result will be electromagnetic induction. Electromagnetic induction is a phenomenon that can be described as follows during the event of a coil of wire being passed through a magnetic field or a magnetic field being passed through a coil of wire. Assume that A is the opposite of B. If the field passes in direction A then a direct current in direction A will result in the coil. If the field passes in direction B then a direct current in direction B will result in the coil. If the polarity of the magnet is reversed then: If the field passes in direction A then a direct current in direction B will result in the coil and if the field passes in direction B then a direct current in direction A will result in the coil. Our example with two collector coils on opposing sides of the chamber and two permanent magnets with opposite polarities facing outward will create two circuits of AC current that are in opposite phase of each other.

There are two primary problems that result from the current electricity model that the X-watt Power Motor will solve. The first problem is that in order to get the shaft to spin in an electricity generator some sort of physical energy is required and that is always associated with some form of pollution. Even the so-called green or clean energy group which include wind, hydro, and geothermal require that the natural landscape be altered. Additionally, they can only provide a small portion of the electricity that humans require and electricity under the current model is only a portion of the overall use of energy. The alternative is to burn fossil fuels, which have a similar negative impact on the natural landscape, and when burned release green house gases that contribute to human caused climate change. To further compound the problem, industrialization, which requires the use of these types of energy, is relatively young and has only been adapted to by a minority of the humans on earth. The rest will soon be joining in and the demand will increase making the need for an effective and truly clean source of energy more crucial than ever before.

The second problem that results from the current electricity model is that the ability to use electricity lacks mobility. Electricity powered automobiles, boats, and aircraft lack viability because extension cords are too short. Electric motors are tethered to electrical transmission lines, transmission lines are tethered to generating stations which are tethered to rail lines to get coal, or gas pipelines, or the wind, hydro, or geothermal facility from which they derive their energy source. As a consequence of this problem an overwhelming majority of cars, boats, and planes run on fossil fuels which brings us back to the first problem. Although rechargeable battery systems which have been in development for several decades show some promise as a solution to this problem they would still have to be recharged. Even if you recharged them with an absolutely clean source of electricity such as an X-watt Power Motor it would still make more sense to simply put the X-watt Power Motor in the vehicle because it is a more powerful motor and it doesn't need to be recharged.

### DETAILED DESCRIPTION OF THE INVENTION

The Invention is an X-watt Power Motor. An X-watt Power Motor is comprised of one or more housing units. Each housing unit is comprised of one or more chambers, which are arranged in single file. Each housing unit has a shaft, which goes through the center of each chamber and is supported by bearings that allow it to spin freely. One end of the shaft protrudes out of one end of the housing unit so that the torque generated from the X-watt Power Motor can be utilized.

Chambers can be one of three different types, which include motor type, generator type, or combined type. In all types of chambers the shaft has one or more permanent magnets attached to it. There should usually be an even number of magnets placed on opposite sides of the shaft so that the balance of the shaft is not altered as it spins. The permanent magnets can be extended away from the shaft whatever distance the design allows for. The permanent magnets do not have to actually be permanent magnets; they could be electromagnets with wires run down the extender and along the shaft to bushings where they receive their electrical supply. These would generally be receiving direct current in the appropriate direction however there are possible instances in which alternating current could be useful. They can also be transformer magnets (a term that will be explained momentarily). They can also be any combination of the above except it should be kept in mind that a standard alternating current electromagnet will not work compatibly with a permanent magnet for this application.

Motor type chambers are comprised of electrical transformers with an equal number of wrappings for the primary coil and the secondary coil. Since these are used as both transformers and electromagnets they are referred to as Transformer Magnets. Transformer magnets in a motor type chamber fulfill the same function as an electromagnet does in an electric motor. Which is to attract and repulse the permanent magnets and cause the shaft to spin. For this reason the polarities of the permanent magnets in a motor type chamber are always alternated.

Generator type chambers are comprised of collector coils that are mounted so that the permanent magnets will spin passed them causing electromagnetic induction and generating electricity. The type of current that they generate depends on the polarity of the permanent magnets. If the polarities are all the same it will be direct current and if the polarities are alternated it will be alternating current. The decision on which type of current to use should be based on what the electricity is being used for. Since the use of transformer magnets allows for the input electricity to be passed on to another it is unlikely that the use of generator type chambers will be necessary in any X-watt Power Motors that are not designed for the primary purpose of generating electricity. For that purpose the standard of voltage and cycles per second in the country of use should be considered. In that scenario an example would be to have one motor type chamber that is supplied power from a rechargeable battery system and put through a DC to AC converter of the proper specifications. One DC generator type chamber could be used to recharge the battery and the rest of the chambers could be AC generator type chambers which will out put AC at the proper cycles per second since they are running in sync with the motor chamber.

The Combined Type Chambers are comprised of both Collector Coils and Transformer Magnets. The combination of a collector coil flanked by two transformer magnets is called a Coil Set. The transformer magnets in a coil set are referred to as leading and lagging to indicate their position to the collector coil in relation to the direction of the permanent magnets movement. The term Chamber Configuration refers to the number of Coil sets and the number of permanent magnets in a chamber. The chamber configuration is expressed as two numbers with a colon between them. For example a chamber configuration of 3:2 means that the chamber has three coil sets and two permanent magnets. Giving each of these units numbers might be of aid when designing the electrical circuitry for the unit. A Conventional Chamber Configuration is one where if the wire of the collector coil is run continuously to the leading and lagging transformer magnets, to form a closed circuit, so that the leading transformer magnet has an opposite or attractive polarity to the permanent magnet and the lagging transformer magnet has the same or repulsive polarity to the permanent magnet then no adjacent transformer magnets would ever have different polarities. That being the case the leading transformer magnet of one coil set could, but should not be, combined with the lagging transformer magnet of the next coil set. A chamber configuration of 3:2, being conventional, would be comprised of 3 collector coils, 3 transformer magnets, and 2 permanent magnets. Each transformer magnet will have one coil wrapping that will cause it to receive a voltage that is opposite of the permanent magnet as it passes the collector coil for which it is the leading transformer magnet and a second coil wrapping that will cause it to receive a voltage that is the same polarity for the collector coil for which it is the lagging transformer magnet. The reason that the transformer magnet should not be combined is only due to circuitry considerations. The situation, in which the wire of the collector coil is run continuously to the leading and lagging transformer magnets to form a closed circuit, is only applicable in a single chambered single housing unit system. However, as far as spatial considerations are concerned it is a good idea to combine the transformer magnets. The smaller the space required for the transformer magnet the larger the space will be for collector coils which will provide the unit more electrical production. The solution is to place the leading and lagging transformer magnets from adjacent coil sets one above the other as viewed parallel to the coil set which is also next to each other as viewed parallel to the shaft. This set of transformer magnets is referred to as a single unit and the leading transformer magnet is called A and the lagging is B.

The circuitry for the use of the electricity being generated at the collector coils is extremely flexible and can therefor sometimes be rather complicated. The predominant thought is that due to the fact that transformer magnets allow their input voltage to be passed through from their output it is best to combine the voltage from all of the same numbered collector coils in every chamber and pass it through all of the leading transformer magnets of the coil set in every chamber and then reverse it and run it through every lagging transformer magnet of the coil set in every chamber and then output it to recharge the battery. In X-watt Power Motor systems with multiple housing units of multiple chambers the voltage can be combined from all of the chambers in the entire system and passed through accordingly.

In most conventional chamber units it is possible to combine all of the voltage from all of the collector coils in the chamber and route it through all of the transformer magnets in the chamber. The switching requirements necessary to ensure proper polarity to each transformer magnet can be accomplished by adding a Switching Drum to the housing unit, which is comprised of a drum, attached to the shaft. The circuits can be run to the drum and connect to it by bushings. Electrical connectors on the drum can complete the circuit in the proper manner based on the current state of the shaft. Use of this method requires limiting the switching to a minimum so in multi chamber units or multi housing units the current should be run through like transformer magnets of all the chambers then switched for application to other like transformer magnets of all chambers. It should be considered unwise to attempt to use electronic switching due to the high speed, lack of reliability of electronics, and the close proximity of high voltage to electronic circuits.

The voltage being applied to transformer magnets that supply supplemental magnetism to the permanent magnets or are there in place of the permanent magnets have some unique requirements. This type of transformer magnet is referred to as a permanent transformer magnet. The voltage applied needs to be constant or direct current in order to maintain a consistent magnetic polarity but transformers only work using alternating current. To overcome this issue a generator type chamber can be added to the housing unit. The purpose of this chamber is to generate a very small counter voltage for the permanent transformer magnets in the other chambers. The counter voltage will be applied to the permanent transformer magnets when they are passing the transformer magnets and then a strong voltage will be applied as the permanent transformer magnets pass the collector coils. This in effect will create an off balance alternating current or a pulsing direct current that will allow the permanent transformer magnets to act as transformers and act as electromagnets with a consistent polarity.

The permanent magnet configuration in this chamber should be identical to that of the combined type chambers or motor type chambers that the permanent transformer magnets which could experience the issue are in. The collector coil configuration in this chamber should have the coils aligned with the transformer magnets of the combined type chambers or motor type chambers that the permanent transformer magnets which could experience the issue are in. Permanent transformer magnets should not be used in this chamber because an increased counter voltage is counter productive to the purpose of this chambers existence.

The voltage coming from the collector coils and being combined to go to the transformer magnets can be controlled with an electrical switching system and used as an accelerator for X-watt Power Motors that are deployed in automobiles, trucks and boats. For example, A motor with seven combined type chambers could run on the voltage produced from one chamber while idling. As the accelerator pedal is pressed down the number of chambers providing voltage to the motor increases and thus provide more torque to the vehicle.

1. An electric motor that uses electrical transformers as electromagnets thus enabling the electricity used to run the motor to be passed to another electrical transformers being used as an electromagnet or to any other device that uses electricity.

2. An electric motor containing one or more coils of electrical wire aligned and connected in a way that the magnets in motion in the motor cause electromagnetic induction and voltage to flow through the electrical wire.

3. A device claimed in claim 1 where the primary purpose of the device is an electricity generator, or the device is called an electricity generator, or the device outputs electricity.

4. The device claimed in claim 2, where one or more coils of electrical wire are aligned and connected in a way that allows magnets in motion which derive motion from the torque of the motors shaft, but are not the same magnets being moved by the electromagnets in the motor, to cause electromagnetic induction and voltage to flow through the electrical wire.

5. A device claimed in claim 2 where the primary purpose of the device is an electricity generator, or the device is called an electricity generator, or the device outputs electricity.

6. A device claimed in claim 4 where the primary purpose of the device is an electricity generator, or the device is called an electricity generator, or the device outputs electricity.
